(19) United States
(12) Patent Application Publication
(10) Pub. No.: US 2026/0225826 A1
(43) Pub. Date: Aug. 6, 2026

(54) SORTING MECHANISM FOR A CONVEYOR

(71) Applicant: Intelligrated Headquarters, LLC, Mason, OH (US)

(72) Inventors: Anthony J. Turco, Liberty Twp, OH (US); Danial Lewis Kosht, Loveland, OH (US)

(21) Appl. No.: 19/046,072

(22) Filed: Feb. 5, 2025

(51) Int. Cl. B65G 47/46; B65G 47/82

(52) U.S. Cl. CPC B65G 47/46; B65G 47/82

(57) ABSTRACT

A sorting mechanism for a conveyor is disclosed. The sorting mechanism comprising one or more pushers, and at least one actuator unit coupled to the one or more pushers, wherein the at least one actuator unit is installed underneath a plane of a plurality of rollers of the conveyor. Further, the at least one actuator unit is configured to move the one or more pushers in a lateral direction along an axis and in between the plurality of rollers to sort one or more objects on the conveyor.

### TECHNOLOGICAL FIELD

Example embodiments of the present disclosure relate generally to a sorting mechanism, and more particularly, to a sorting mechanism for a conveyor and a method of sorting one or more objects on the conveyor.

### BACKGROUND

A friction-based sortation system is commonly used for mid-rate transfers with a low number of divert lanes on conveyors. Sortation systems such as pop-up wheel sorters, rotating wheel transfers and pop-up belt transfers (e.g., right angle transfers) are generally known for their simplicity in assembly and operation. The friction-based sortation system offers a cost-effective solution for certain sorting needs. However, despite lower implementation costs, friction-based sortation system have limitations such as slipping or tumbling of high speed flow of objects, thus providing a less efficient sorting particularly in more demanding or high-capacity operations.

The inventors identified numerous deficiencies and problems in existing technologies and processes, which are the subjects of embodiments described herein. Through applied effort, ingenuity, and innovation, many of these deficiencies and problems have been solved by developing solutions that are included in embodiments of the present disclosure, many examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a sorting mechanism is disclosed. The sorting mechanism comprises one or more pushers. The sorting mechanism comprises at least one actuator unit coupled to the one or more pushers. Further, the at least one actuator unit is installed underneath a plane of a plurality of rollers of the conveyor. Further, the at least one actuator unit is configured to move the one or more pushers in a lateral direction along an axis and in between the plurality of rollers to sort one or more objects on the conveyor.

In some embodiments, the at least one actuator unit comprises a motor coupled to a screw shaft for providing rotational movement to the screw shaft. In some embodiments, the one or more pushers are mounted on the screw shaft. Further, the rotational movement of the screw shaft facilitates the movement of the one or more pushers in the lateral direction.

In some embodiments, the one or more pushers have a rake-shaped profile and correspond to at least one of a pop-up pusher or a shoe shaped pusher. In some embodiments, the one or more pushers are one or more pop-up pushers, each pop-up pusher being configured to reciprocate vertically between a deployed state or a stowed state. In some embodiments, in the stowed state, the pop-up is positioned below the plurality of rollers to allow the one or more objects to move along the plurality of rollers in a forward direction that is orthogonal to the lateral direction. In some embodiments, in the deployed state, the pop-up pusher protrudes out from in-between the plurality of rollers and laterally moves to push the one or more objects across the plurality of rollers.

In some embodiments, the one or more pushers are one or more shoe shaped pushers, each shoe shaped pusher being connected to the at least one actuator unit via a linking rod such that the shoe shaped pusher is positioned over at least two of the plurality of rollers.

In some embodiments, at least one processor communicatively coupled to the at least one actuator unit. Further, the at least one processor is configured to actuate the at least one actuator unit in a manner to align the one or more pushers in a diagonal pattern while sorting the one or more objects. In some embodiments, the diagonal pattern forms a predefined angle. Further, the predefined angle is determined based at least on an angle of a take-away belt positioned adjacent to the plurality of rollers where the one or more objects are sorted.

In some embodiments, each of the one or more pushers are pop-up pushers that are configured to reciprocate vertically between a deployed state or a stowed state, and the sorting mechanism further comprises at least one processor communicatively coupled to the at least one actuator unit. Further, the at least one processor is configured to actuate each actuator unit to move each of the pop-up pushers from a home position and to an end position and from the end position to the home position, reciprocate each pop-up pusher to the deployed state when the pop-up pusher is moved from the home position and to the end position, and reciprocate each pop-up pusher to the stowed state when the pop-up pusher is moved from the end position to the home position.

In some embodiments, the at least one processor is further configured to actuate a first actuator unit to move a first pop-up pusher from its respective home position and to its respective end position while actuating a second actuator unit to move a second pop-up pusher from its respective end position and to its respective home position.

In another example embodiment, a method of sorting one or more objects on a conveyor is disclosed. The method comprises moving one or more pushers in a lateral direction along an axis and in between a plurality of rollers of the conveyor to sort the one or more objects on the conveyor. Further, the method comprises sorting of the one or more objects involves: rotating, via a motor, a screw shaft to facilitate movement of the one or more pushers in the lateral direction to laterally push the one or more objects from the plurality of rollers and towards a take-away belt positioned adjacent to the plurality of rollers where the one or more objects are sorted.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a top view of a conveyor installed with a sorting mechanism in accordance with an example embodiment of the present disclosure;

FIG. 2 illustrates a stowed state and a deployed state of a pop-up pusher of the sorting mechanism in accordance with an example embodiment of the present disclosure;

FIGS. 3A-3F illustrate sorting of one or more objects by the pop-up pusher of the conveyor of FIG. 1 in accordance with an example embodiment of the present disclosure;

FIG. 4 illustrates a top view of the conveyor installed with a shoe shaped pusher in accordance with another example embodiment of the present disclosure;

FIG. 5 illustrates a perspective view of the conveyor of FIG. 4 in accordance with another example embodiment of the present disclosure;

FIG. 6 illustrates another perspective view of the conveyor of FIG. 4 in accordance with another example embodiment of the present disclosure;

FIG. 7 illustrates a top view of the conveyor of FIG. 4 in accordance with another example embodiment of the present disclosure; and

FIG. 8 illustrates sorting of the one or more objects by the shoe shaped pusher of the conveyor of FIG. 4 in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a sorting mechanism is disclosed. Embodiments of the present disclosure may comprise one or more pushers. Embodiments of the present disclosure may comprise at least one actuator unit that is coupled to the one or more pushers. The at least one actuator unit may be installed underneath a plane of a plurality of rollers of the conveyor. The at least one actuator unit may be configured to move the one or more pushers in a lateral direction along an axis and in between the plurality of rollers to sort one or more objects on the conveyor.

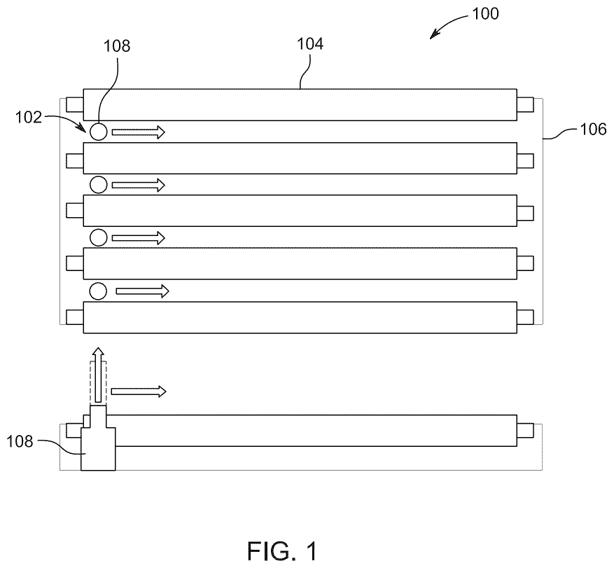

FIG. 1 illustrates a top view of a conveyor 100 installed with a sorting mechanism 102, in accordance with an example embodiment of the present disclosure.

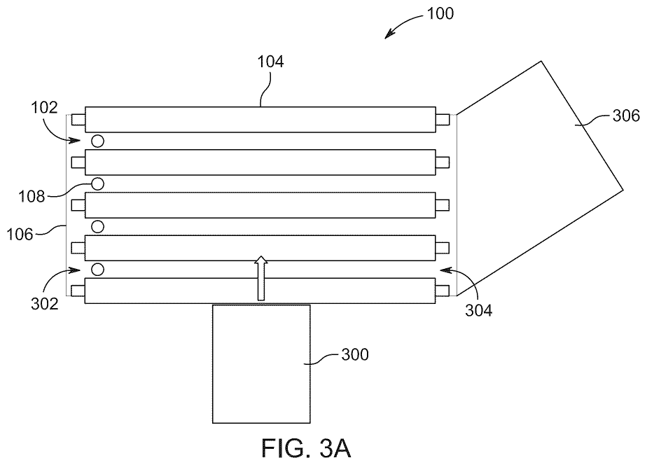

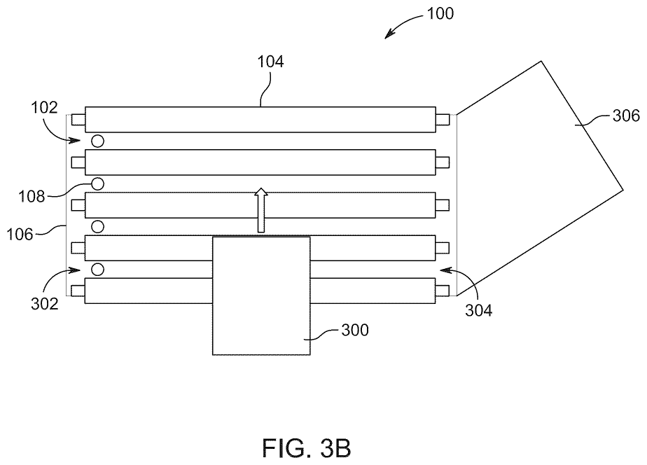

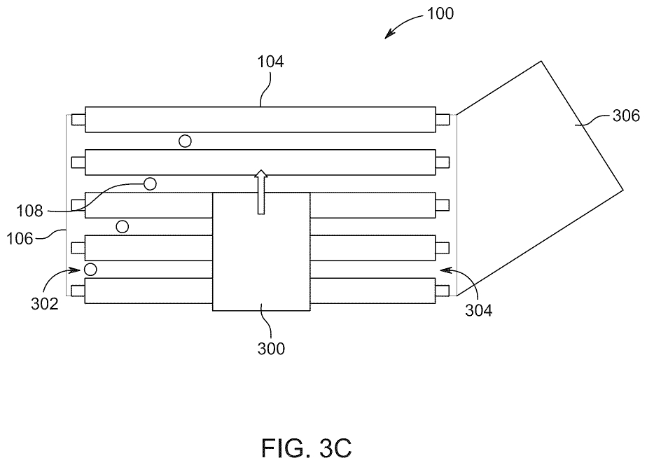

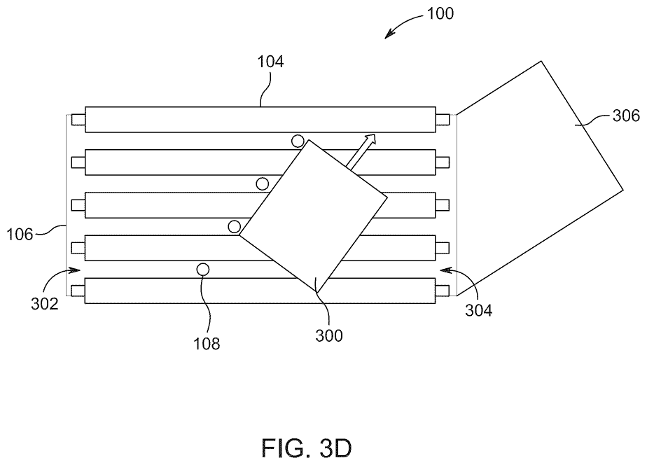

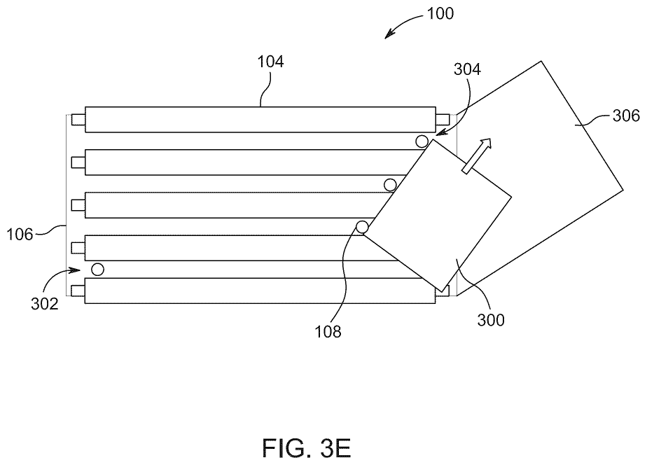

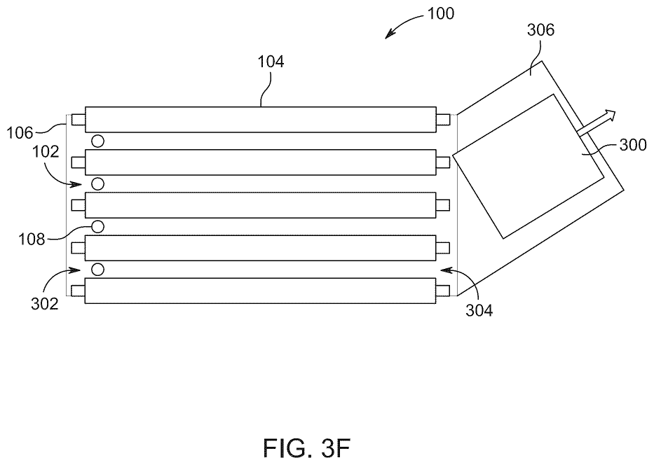

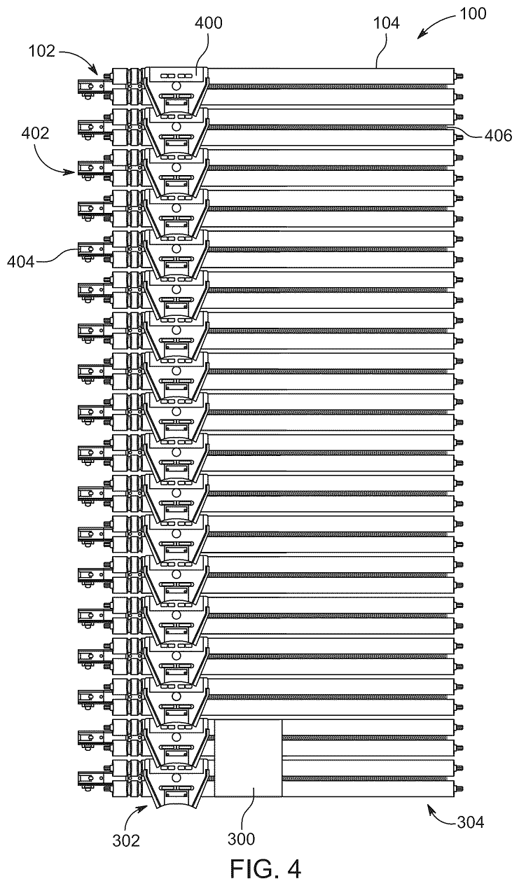

In some embodiments, the conveyor 100 may comprise the sorting mechanism 102 and a plurality of rollers 104. In some embodiments, the sorting mechanism 102 may comprise one or more pushers and at least one actuator unit 402 (FIG. 4). In some embodiments, the conveyor 100 may be installed within an industrial environment. Further, the industrial environment may comprise at least one of a warehouse, manufacturing plant, assembling plant, distribution center etc. In some embodiments, the conveyor 100 may be configured to transport one or more objects 300 (FIG. 3A) from location to another location within the industrial environment. In some embodiments, the conveyor 100 may be configured to transfer the one or more objects 300 either upstream or downstream within the corresponding industrial environment. In some embodiments, the conveyor 100 may correspond to a roller conveyor, sorter conveyor etc.

In some embodiments, the conveyor 100 may comprise a frame 106. In some embodiments, the frame 106 may be configured to provide a structural base to the conveyor 100 when installed within the industrial environment. In some embodiments, the frame 106 may comprise one or more side rails (not shown) and a plurality of supporting bars (not shown). In some embodiments, the one or more side rails of the conveyor 100 may be configured to prevent tripping of the one or more objects 300 while moving over the conveyor 100. In some embodiments, the plurality of supporting bars may be attached with the one or more side rails. Further, the plurality of supporting bars may be configured to provide support to the conveyor 100 over a ground surface within the industrial environment. In some embodiments, the conveyor 100 may comprise the plurality of rollers 104. In some embodiments, the plurality of rollers 104 may be integrated with the frame 106 of the conveyor 100. In some embodiments, the plurality of rollers 104 may be configured to transport the one or more objects 300 over the conveyor 100. In some embodiments, the plurality of rollers 104 may correspond to plurality of motor driven rollers (MDR). In some embodiments, the motor driven rollers may comprise the plurality of rollers 104 each coupled with at least one motor 404 (FIG. 4) that may be configured to drive the plurality of motor driven rollers.

In some embodiments, each of the plurality of rollers 104 may comprise an axle and an outer shell. In some embodiments, the axle of the each of the plurality of rollers 104 may facilitate coupling of the plurality of rollers 104 with the frame 106. In some embodiments, the axle of the plurality of rollers 104 may define a rotating axis. In some embodiments, the outer shell of each of the plurality of rollers 104 may be configured to rotate over the rotating axis. In some embodiments, the outer shell of the plurality of rotating axis may be configured to be in contact with the one or more objects 300 during movement of the one or more objects 300 over the conveyor 100. In various examples, the conveyor 100 may comprise a plurality of idler rollers and a driving assembly. In some embodiments, the plurality of idler rollers may be configured to transport the one or more objects 300 over the conveyor 100. In some embodiments, the driving assembly may be configured to drive the plurality of idler rollers to transport the one or more objects 300 over the conveyor 100.

In some embodiments, the conveyor 100 may be coupled with a take-away belt 306 (i.e., an another conveyor) (FIG. 3A) to facilitate transfer of the one or more objects 300 between different sections of the industrial environment. In some embodiments, the conveyor 100 coupled with the take-away belt 306 may enable management of flow of the one or more objects 300 during various operations within the industrial environment. Further, the operations may include but are not limited to sorting, assembling, packing, shipping etc. In some embodiments, the conveyor 100 may be coupled with the take-away belt 306 through various mechanical or automated linkages. Further, the one or more objects 300 are required to be sorted such that the one or more objects 300 gets transferred from the conveyor 100 to the take-away belt 306. In some embodiments, the one or more objects 300 may get sorted in accordance with one or more parameters associated with the one or more objects 300. The one or more parameters may include but are not limited to size, weight, shape, type etc. In some embodiments, the sorting mechanism 102 may be operationally coupled with the conveyor 100. Further, the sorting mechanism 102 may be configured to sort the one or more objects 300 to while moving over the conveyor 100.

In some embodiments, the sorting mechanism 102 may comprise the one or more pushers. In some embodiments, the one or more pushers may be integrated within the conveyor 100 such that each pusher of the one or more pushers is positioned in proximate to at least a pair of rollers from the plurality of rollers 104. In some embodiments, the one or more pushers may be configured to move in a lateral direction across the conveyor 100 to push the one or more objects 300 towards the take-away belt 306. In some embodiments, the one or more pushers may be configured to move perpendicular to movement of the one or more objects 300 over the conveyor 100. In some embodiments, the one or more pushers may correspond to at least one of a pop-up pusher 108 or a shoe shaped pusher 400 (FIG. 4). In some embodiments, each of the pop-up pusher 108 or the shoe shaped pusher 400 may define a rake-shaped profile that is the pop-up pusher 108 or the shoe shaped pusher 400 act like a rake that pushes the one or more objects 300 over the conveyor 100. In some embodiments, the rake-shaped profile provides a positive contacting sweeper that enables sortation operation of the one or more objects 300 in desired time. In some embodiments, the sorting mechanism 102 may comprise at least one actuator unit 402 (FIG. 4). In some embodiments, the at least one actuator unit 402 may be coupled with the one or more pushers. In some embodiments, the at least one actuator unit 402 may be installed underneath a plane of the plurality of rollers 104 of the conveyor 100.

In some embodiments, the at least one actuator unit 402 of the sorting mechanism 102 may be configured to move the one or more pushers in the lateral direction along an axis and in between the plurality of rollers 104 to sort the one or more objects 300 on the conveyor 100. In various examples, the at least one actuator unit 402 may correspond to a motorized actuator, a pneumatic actuator, a hydraulic actuator, a magnetic actuator etc. In some embodiments, the at least one actuator unit 402 may be configured to provide movement to the one or more pushers perpendicular to the plane of the plurality of rollers 104. In various examples, the plurality of rollers 104 may be configured to provide a forward movement to the one or more objects 300 over the conveyor 100. In various examples, the at least one actuator unit 402 may be configured to move the one or more pushers in the lateral direction along with the one or more objects 300 over the conveyor 100. In some embodiments, the one or more pushers may be configured to push the one or more objects 300 toward the take-away belt 306 to sort the one or more objects 300.

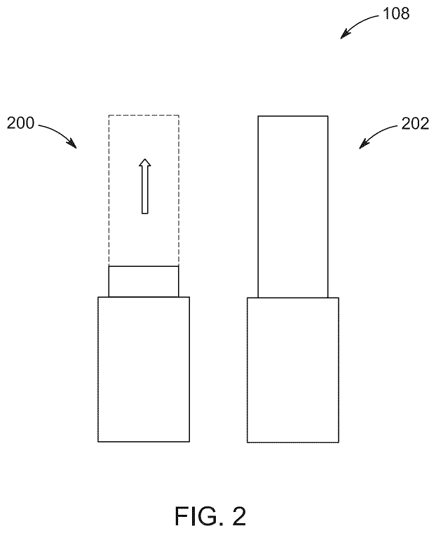

FIG. 2 illustrates a stowed state 200 (image on left) and a deployed state 202 (image on right) of the pop-up pusher 108 of the sorting mechanism 102, in accordance with an example embodiment of the present disclosure.

In some embodiments, the conveyor 100 may be installed with the sorting mechanism 102. In some embodiments, the sorting mechanism 102 may comprise the one or more pushers. In some embodiments, the one or more pushers may correspond to at least one of the pop-up pusher 108 or the shoe shaped pusher 400. In one instance, when the one or more pushers corresponds to the pop-up pusher 108, then the pop-up pusher 108 may be coupled with the at least one actuator unit 402. In some embodiments, each pop-up pusher 108 may be positioned between a pair of the plurality of rollers 104. In some embodiments, each of the pop-up pusher 108 may be coupled with the at least one actuator unit 402 through a linking rod (not shown) or each pop-up pusher 108 may be coupled to a respective actuator unit of the at least one actuator unit 402. In some embodiments, the at least one actuator unit 402 may be configured to move each of the pop-up pusher 108 in the lateral direction along the axis and in between the rollers 104 to sort the one or more objects 300 on the conveyor 100. In some embodiments, each actuator unit 402 may be configured to move a respective pop-up pusher 108 in the lateral direction along the axis and in between the rollers 104 to sort the one or more objects 300 on the conveyor 100.

In some embodiments, the one or more pushers may be one or more pop-up pushers 108, each pop-up pusher 108 of the one or more pop-up pushers 108 may be configured to reciprocate vertically between the deployed state 202 or in the stowed state 200. In some embodiments, the pop-up pusher 108 may be coupled with a vertical actuator (not shown) that may include but is not limited to a linear actuator, a pneumatic actuator, a magnetic actuator etc. In some embodiments, the vertical actuator may be configured to actuate the pop-up pusher 108 to reciprocate vertically from the deployed state 202 to the stowed state 200, and vice-versa. In some embodiments, each of the pop-up pusher 108 may be coupled with the at least one actuator unit 402 (or a respective actuator unit 402). Further, the at least one actuator unit 402 may be configured to move the pop-up pusher 108 in the lateral direction when the pop-up pusher 108 is positioned in the deployed state 202. In some embodiments, the pop-up pusher 108 may be configured to move along the axis parallel to the plurality of rollers 104. Further, the pop-up pusher 108 may be configured to push the one or more objects 300 towards the take-away belt 306 while moving in the lateral direction over the conveyor 100 to sort the one or more objects 300 on the conveyor 100.

In one instance, when the pop-up pusher 108 is in the stowed state 200, then the pop-up pusher 108 may be positioned below the plurality of rollers 104 to allow the one or more objects 300 to move along the plurality of rollers 104 in a forward direction that may be orthogonal to the lateral direction. In another instance, when the pop-up pusher 108 is in the deployed state 202, then the pop-up pusher 108 may protrude out from in-between the plurality of rollers 104 and laterally move to push the one or more objects 300 from the plurality of rollers 104. The pop-up pusher 108 may protrude out above the plurality of rollers 104 by at least one inch, such as by at least three inches, such as by at least six inches. In some embodiments, the pop-up pusher 108 may be configured sort the one or more objects 300 on the conveyor 100 and push the one or more objects 300 towards the take-away belt 306.

FIGS. 3A-3F illustrate sorting of the one or more objects 300 by the pop-up pusher 108 of the conveyor 100 of FIG. 1, in accordance with an example embodiment of the present disclosure.

In some embodiments, the sorting mechanism 102 of the conveyor 100 may comprise the one or more pushers. Further, the one or more pushers may correspond to the pop-up pusher 108. Further, each of the pop-up pusher 108 may be positioned below the plurality of rollers 104. In various examples, the conveyor 100 may be installed with at least one sensing unit. Further, the at least one sensing unit may comprise at least one of one or more sensors, dimensioner, camera etc. In some embodiments, the at least one sensing unit may be configured to determine dimensions of the one or more objects 300. Further, the at least one sensing unit may be configured to detect distance between the one or more objects 300. In some embodiments, the at least one sensing unit may be configured to generate one or more signals. Further, the one or more signals may comprise dimensions of the one or more objects 300 and the distance between the one or more objects 300. In some embodiments, the sorting mechanism 102 may comprise at least one processor (not shown). Further, the at least one processor may be communicatively coupled with the at least one sensing unit.

In some embodiments, the at least one processor may include suitable logic, circuitry, and/or interfaces that are operable to execute one or more instructions stored in a memory to perform predetermined operations. In one embodiment, the at least one processor may be configured to decode the one or more instructions and execute the one or more instructions that are stored within the memory. The at least one processor may be configured to execute one or more computer-readable program instructions, such as program instructions to carry out any of the functions described in this description. Further, the at least one processor may be implemented using one or more processor technologies known in the art such as central processing unit (CPU), field-programmable gate array (FPGA), digital signal processors (DSP), etc. Examples of the at least one processor may comprise at least one of, one or more general purpose processors and/or one or more special purpose processors that may be designed to handle the sorting mechanism 102 of the conveyor 100.

In some embodiments, the at least one processor may be configured to receive the one or more signals. In some embodiments, the at least one processor may be communicatively coupled to the vertical actuator coupled with each of the pop-up pusher 108 and the at least one actuator unit 402. In some embodiments, the at least one processor may be configured to actuate the vertical actuator to reciprocate each pop-up pusher 108 vertically between the deployed state 202 or the stowed state 200. In some embodiments, the at least one processor may be configured to actuate the at least one actuator unit 402. In some embodiments, the at least one actuator unit 402 may be installed underneath the plurality of rollers 104 of the conveyor 100. In some embodiments, the at least one actuator unit 402 may be configured to move at least one of the pop-up pushers 108 from a home position 302 to an end position 304 and from the end position 304 to the home position 302. In some embodiments, the end position 304 may correspond to a position of the pop-up pusher 108 that is proximal to the take-away belt 306. In some embodiments, the home position 302 may correspond to a position of the pop-up pusher 108 that is distal to the take-away belt 306.

In some embodiments, the at least one actuator unit 402 may comprise a motor 404 (FIG. 4) and a screw shaft 406 (FIG. 4). In some embodiments, the motor 404 may be coupled with a power source (not shown). In some embodiments, the screw shaft 406 may be positioned between the plurality of rollers 104. In some embodiments, the motor 404 may be coupled with the screw shaft 406. In some embodiments, the motor 404 may be configured to provide rotational movement to the screw shaft 406. Further, the one or more pushers (e.g., the pop-up pusher 108 or the shoe shaped shorter) may be coupled with the screw shaft 406 through the linking rod. In some embodiments, the rotational movement of the screw shaft 406 may facilitate the lateral movement of the one or more pushers across the plane of the plurality of rollers 104 (e.g., from the home position 302 to the end position 304 and vice-versa).

In some embodiments, the at least one processor may be configured to actuate the vertical actuator to reciprocate each pop-up pusher 108 to the deployed state 202 when the pop-up pusher 108 is moved from the home position 302 to the end position 304. In some embodiments, the at least one processor may be configured to actuate the vertical actuator to reciprocate each pop-up pusher 108 to the stowed state 200 when the pop-up pusher 108 is moved from the end position 304 to the home position 302. In various examples, the conveyor 100 may comprise a first actuator unit (not shown) and a second actuator unit (not shown).

In various examples, the at least one processor may be communicatively coupled to the first actuator unit and the second actuator unit. Further, the at least one processor may be configured to actuate the first actuator unit to move a first pop-up pusher 108 from its respective home position 302 and to its respective end position 304 while actuating the second actuator unit to move a second pop-up pusher 108 from its respective end position 304 to its respective home position 302. For example, and with reference to FIG. 3D, three of the pop-up pushers 108 are in a deployed state 202 and are pushing the object 300 towards the take-away belt 306. One of the pop-up pushers 108 (e.g., the bottom-most pop-up pusher, as depicted on the page) is not being utilized to push the object 300 towards the take-away belt 306 and is moving towards its home position 302, as depicted in FIG. 3E. As such, at least one of the pop-up pushers 108 may begin to travel towards the end position 304 but may return to the home position 302 without making it to the end position 304. When returning to the end position 304, the pop-up pusher may be in the stowed state 200.

In some embodiments, the at least one processor may be configured to actuate the at least one actuator unit 402 in a manner to align the one or more pushers (i.e., the pop-up pusher 108) in a diagonal pattern (as illustrated in FIG. 3C) while sorting the one or more objects 300. In some embodiments, upon actuation, the motor 404 of the at least one actuator unit 402 may be configured to rotate the screw shaft 406 to facilitate movement of each of the pop-up pusher 108 in the lateral direction across the conveyor 100 (i.e., from the home position 302 to the end position 304 and vice-versa). In some embodiments, the diagonal pattern may form a predefined angle. In some embodiments, the predefined angle may be determined based at least on an angle of the take-away belt 306. Further, the take-away belt 306 may be positioned adjacent to the plurality of rollers 104 where the one or more objects 300 are sorted. In some embodiments, the at least one processor may be configured to calibrate the predefined angle of the diagonal pattern formed by the pop-up pusher 108, based at least one the dimensions of the one or more objects 300.

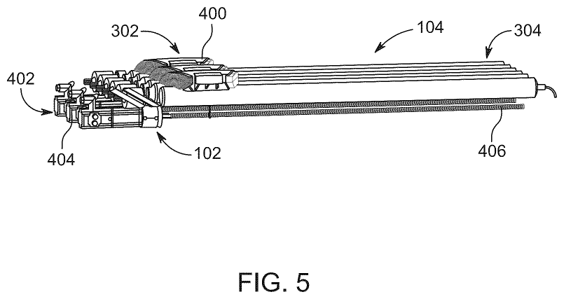

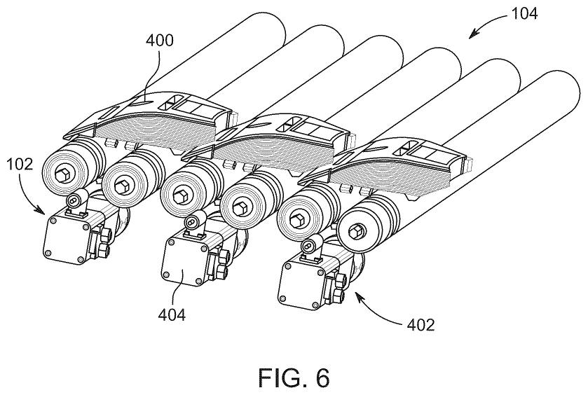

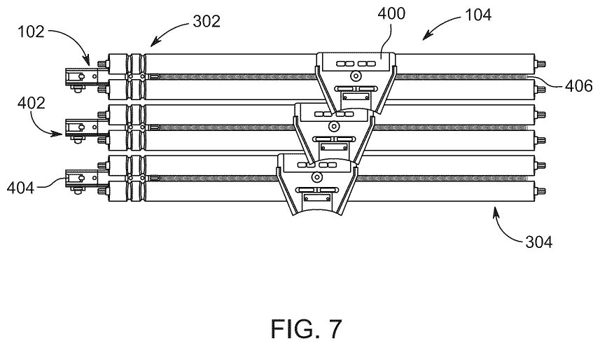

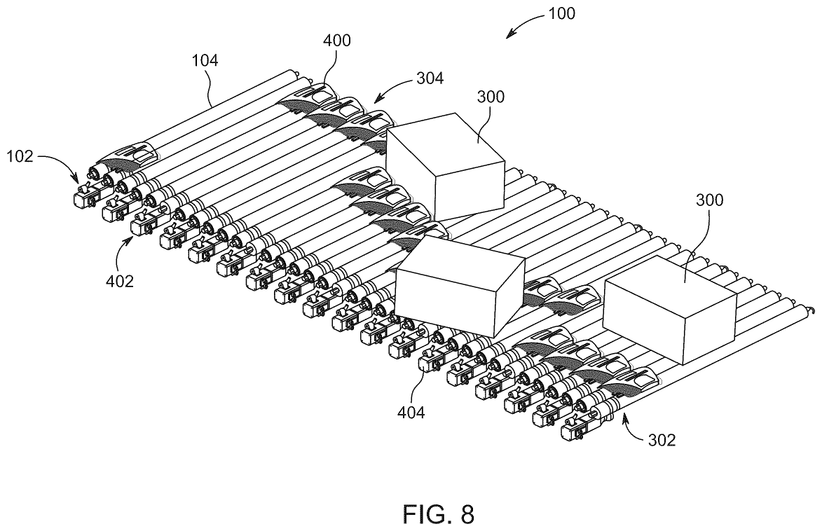

FIG. 4 illustrates a top view of the conveyor 100 installed with the shoe shaped pusher 400, in accordance with another example embodiment of the present disclosure. FIG. 5 illustrates a perspective view of the conveyor 100 as of FIG. 4, in accordance with another example embodiment of the present disclosure. FIG. 6 illustrates another perspective view of the conveyor 100 as of FIG. 4, in accordance with another example embodiment of the present disclosure. FIG. 7 illustrates another top view of the conveyor 100 as of FIG. 4, in accordance with another example embodiment of the present disclosure. FIG. 8 illustrates sorting of the one or more objects 300 by the shoe shaped pusher 400 of the conveyor 100 as of FIG. 4, in accordance with an example embodiment of the present disclosure.

In some embodiments, the conveyor 100 may be installed with the sorting mechanism 102. In some embodiments, the sorting mechanism 102 may comprise the one or more pushers. In some embodiments, the one or more pushers are the one or more shoe shaped pusher 400. In another instance, when the one or more pushers correspond to the shoe shaped pusher 400, then the shoe shaped pusher 400 may be coupled with the at least one actuator unit 402. In some embodiments, the shoe shaped pusher 400 may be constructed with a shape such as but are not limited to a trapezoidal shape, cuboidal shape, triangular shape etc. In some embodiments, the shoe shaped pusher 400 (i.e., the one or more pushers) may define the rake-shaped profile. In some embodiments, each of the shoe shaped pusher 400 may define a plurality of sides each having a frictional surface. Further, the frictional surface of the shoe shaped pusher 400 may facilitate the shoe shaped pusher 400 to easily push the one or more objects 300 towards the take-away belt 306. In some embodiments, the shoe shaped pusher 400 may be positioned between at least two of the plurality of rollers 104. In some embodiments, each of the shoe shaped pusher 400 may be coupled with the at least one actuator unit 402 via the linking rod such that the show pusher may get positioned over the at two of the plurality of rollers 104. In some embodiments, the at least one actuator unit 402 may be configured to laterally move each of the shoe shaped pusher 400 along the axis and in between the rollers to sort the one or more objects 300 on the conveyor 100.

In some embodiments, each of the shoe shaped pusher 400 may be coupled with the at least one actuator unit 402. Further, the at least one actuator unit 402 may be configured to laterally move the shoe shaped pusher 400. In some embodiments, the shoe shaped pusher 400 may be configured to move along the axis parallel to the plurality of rollers 104. Further, the shoe shaped pusher 400 may be configured to push the one or more objects 300 while moving laterally over the conveyor 100 to sort the one or more objects 300 on the conveyor 100. In some embodiments, the at least one processor may be communicatively coupled to the at least one actuator unit 402. In some embodiments, the at least one processor may be configured to actuate the at least one actuator unit 402.

In some embodiments, the at least one actuator unit 402 may be installed underneath the plurality of rollers 104 of the conveyor 100 and positioned in between the plurality of rollers 104. In some embodiments, the at least one actuator unit 402 may be coupled to each of the shoe shaped pusher 400 via the linking rod. In some embodiments, the at least one actuator unit 402 may be configured to laterally move the shoe shaped pusher 400 along the axis and in between the plurality of rollers 104 to sort the one or more objects 300 on the conveyor 100. In some embodiments, the at least one actuator unit 402 may be configured to move each of the shoe shaped pusher 400 in from the home position 302 to the end position 304 and from the end position 304 to the home position 302.

In some embodiments, the at least one actuator unit 402 may comprise the motor 404 and the screw shaft 406. In some embodiments, the screw shaft 406 may be positioned between the plurality of rollers 104. In some embodiments, the motor 404 may be coupled with the screw shaft 406. In some embodiments, the motor 404 may be configured to provide rotational movement to the screw shaft 406. Further, the one or more pushers (e.g., the shoe shaped shorter) may be coupled with the actuator unit. In some embodiments, the one or more pushers may be mounted on the screw shaft 406 defines the rake-shaped profile. In some embodiments, the rotational movement of the screw shaft 406 may facilitate the lateral movement of the one or more pushers across the plane of the plurality of rollers 104 (e.g., from the home position 302 to the end position 304 and vice-versa).

In some embodiments, the at least one processor may be configured to actuate the at least one actuator unit 402 in a manner to align the one or more pushers (i.e., the shoe shaped pusher 400) in a diagonal pattern while sorting the one or more objects 300. In some embodiments, upon actuation, the motor 404 of the at least one actuator unit 402 may be configured to rotate the screw shaft 406 to move each of the shoe shaped pusher 400 in the lateral direction across the conveyor 100. In some embodiments, the diagonal pattern may form a predefined angle. In some embodiments, the predefined angle may be determined based at least on an angle of the take-away belt 306. Further, the take-away belt 306 may be positioned adjacent to the plurality of rollers 104 where the one or more objects 300 are sorted. In some embodiments, the at least one processor may be configured to calibrate the predefined angle of the diagonal pattern formed by the shoe shaped pusher 400, based at least one the dimensions of the one or more objects 300. In some embodiments, the shoe shaped pusher 400 may be configured to push the one or more objects 300 in the lateral direction and towards the take-away belt 306 that facilitates sorting of the one or more objects 300.

In some embodiments, a method of sorting the one or more objects 300 on the conveyor 100 is disclosed. The method may comprise one or more operations. At an operation, the one or more pushers of the sorting mechanism 102 may be configured to move in a lateral direction along the axis and in between the plurality of rollers 104 of the conveyor 100 to sort the one or more objects 300 on the conveyor 100. In some embodiments, the sorting mechanism 102 may comprise the at least one actuator unit 402. Further, the at least one actuator unit 402 may comprise the motor 404 and the screw shaft 406. At another operation, the motor 404 may be configured to rotate the screw shaft 406 to facilitate movement of the one or more pushers in the lateral direction (e.g., from the home position 302 the end position 304 and vice-versa) to laterally push the one or more objects 300 from the plurality of rollers 104 and towards the take-away belt 306 positioned adjacent to the plurality of rollers 104 where the one or more objects 300 are sorted.

The present invention may offer enhanced efficiency, particularly in high-speed and high-capacity operations of the conveyor 100. The sorting mechanism 102 utilized the one or more pushers to prevent tripping of the one or more objects 300 during the high-speed flow of objects, thereby providing uninterrupted and accurate sorting of the one or more objects 300. The present invention, the at least one actuator unit 402 and the one or more pushers may ensure consistent performance across varied operational demands. Moreover, sorting mechanism 102 may accommodate large volumes of objects without compromising sorting accuracy, resulting in a more efficient workflow. The increased reliability of the sorting mechanism 102 of the conveyor 100 in demanding operations may reduce downtime and operational delays, ensuring continuous flow and minimizing disruptions. Consequently, the present sorting mechanism 102 may optimize throughput, making it ideal for high-demand environments, and may lower operational costs by reducing manual intervention and increasing system uptime.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A sorting mechanism for a conveyor, the sorting mechanism comprising:
one or more pushers; and
at least one actuator unit coupled to the one or more pushers, wherein the at least one actuator unit is installed underneath a plane of a plurality of rollers of the conveyor;
wherein the at least one actuator unit is configured to move the one or more pushers in a lateral direction along an axis and in between the plurality of rollers to sort one or more objects on the conveyor.

2. The sorting mechanism of claim 1, wherein the at least one actuator unit comprises a motor coupled to a screw shaft for providing rotational movement to the screw shaft.

3. The sorting mechanism of claim 2, wherein the one or more pushers are mounted on the screw shaft, wherein the rotational movement of the screw shaft facilitates the movement of the one or more pushers in the lateral direction.

4. The sorting mechanism of claim 1, wherein the one or more pushers have a rake-shaped profile and correspond to at least one of a pop-up pusher or a shoe shaped pusher.

5. The sorting mechanism of claim 1, wherein the one or more pushers are one or more pop-up pushers, each pop-up pusher being configured to reciprocate vertically between a deployed state or a stowed state.

6. The sorting mechanism of claim 5, wherein in the stowed state, the pop-up pusher is positioned below the plurality of rollers to allow the one or more objects to move along the plurality of rollers in a forward direction that is orthogonal to the lateral direction.

7. The sorting mechanism of claim 5, wherein in the deployed state, the pop-up pusher protrudes out from in-between the plurality of rollers and laterally moves to push the one or more objects from the plurality of rollers.

8. The sorting mechanism of claim 1, wherein the one or more pushers are one or more shoe shaped pushers, each shoe shaped pusher being connected to the at least one actuator unit via a linking rod such that the shoe shaped pusher is positioned over at least two of the plurality of rollers.

9. The sorting mechanism of claim 1, further comprising at least one processor communicatively coupled to the at least one actuator unit, wherein the at least one processor is configured to actuate the at least one actuator unit in a manner to align the one or more pushers in a diagonal pattern while sorting the one or more objects.

10. The sorting mechanism of claim 9, wherein the diagonal pattern forms a predefined angle, wherein the predefined angle is determined based at least on an angle of a take-away belt positioned adjacent to the plurality of rollers where the one or more objects are sorted.

11. The sorting mechanism of claim 1, wherein:
each of the one or more pushers are pop-up pushers that are configured to reciprocate vertically between a deployed state or a stowed state, and
the sorting mechanism further comprises at least one processor communicatively coupled to the at least one actuator unit, wherein the at least one processor is configured to:
actuate each actuator unit to move each of the pop-up pushers (1) from a home position and to an end position and (2) from the end position to the home position,
reciprocate each pop-up pusher to the deployed state when the pop-up pusher is moved from the home position and to the end position, and
reciprocate each pop-up pusher to the stowed state when the pop-up pusher is moved from the end position to the home position.

12. The sorting mechanism of claim 11, wherein the at least one processor is further configured to actuate a first actuator unit to move a first pop-up pusher from its respective home position and to its respective end position while actuating a second actuator unit to move a second pop-up pusher from its respective end position and to its respective home position.

13. A method of sorting one or more objects on a conveyor, the method comprising:
moving one or more pushers in a lateral direction along an axis and in between a plurality of rollers of the conveyor to sort the one or more objects on the conveyor;
wherein sorting of the one or more objects involves rotating, via a motor, a screw shaft to facilitate movement of the one or more pushers in the lateral direction to laterally push the one or more objects from the plurality of rollers and towards a take-away belt positioned adjacent to the plurality of rollers where the one or more objects are sorted.

14. The method of claim 13, wherein the one or more pushers have a rake-shaped profile and correspond to at least one of one or more pop-up pusher or one or more shoe shaped pusher.

15. The method of claim 14, further comprising reciprocating each pop-up pusher of the one or more pop-up pusher that are the one or more pushers vertically between a deployed state or a stowed state.

16. The method of claim 15, further comprising positioning each pop-up pusher below the plurality of rollers to allow the one or more objects move along the plurality of rollers in a forward direction that is orthogonal to the lateral direction in the stowed state.

17. The method of claim 15, further comprising protruding at least one of the one or more pop-up pusher out from in-between the plurality of rollers and laterally move the at least one of the one or more pop-up pusher to push the one or more objects from the plurality of rollers in the deployed state.

18. The method of claim 14, further comprising connecting each shoe shaped pusher of the one or more shoe shaped pusher of the one or more pushers to at least one actuator unit via a linking rod such that the shoe shaped pusher is positioned over at least two of the plurality of rollers.

19. The method of claim 18, further comprising actuating, via at least one processor communicatively coupled to the at least one actuator unit, at least one actuator unit in a manner to align the one or more pushers in a diagonal pattern while sorting the one or more objects.

20. The method of claim 19, wherein the diagonal pattern forms a predefined angle, wherein the predefined angle is determined based at least on an angle of the take-away belt positioned adjacent to the plurality of rollers where the one or more objects are sorted.
